(19) United States
(12) Patent Application Publication
(10) Pub. No.: US 2005/0218109 A1
(43) Pub. Date: Oct. 6, 2005

(54) Container having a plastic ring grip and optional handle

(76) Inventors: Frank E. Semersky, Holland, OH (US); Vincent Le Guen, Evianlesbains (FR)

Correspondence Address: FRASER MARTIN BUCHANAN MILLER LLC, 132C WEST SECOND STREET, PERRYSBURG, OH, 43551-1401, US

(21) Appl. No.: 11/078,449

(22) Filed: Mar. 11, 2005

Related U.S. Application Data
(60) Provisional application No. 60/553,379, filed on Mar. 16, 2004.
(60) Provisional application No. 60/619,972, filed on Oct. 19, 2004.

(51) Int. Cl. B65D 23/10; A47J 45/00; A47J 41/02; B65D 23/00

(52) U.S. Cl. 215/396; 294/31.2; 294/33

(57) ABSTRACT

A plastic container comprises an elastically deformable, substantially cylindrical sidewall, and a plastic ring contacting and embedded into the exterior surface of the sidewall. The plastic ring may optionally include a handle attached thereto. The plastic ring has an inner circumference smaller than the circumference of the plastic container sidewall, so that the container sidewall exterior surface is concave at its point of contact with the plastic ring, thereby providing a grip in the sidewall of the plastic container.

### CROSS-REFERENCE TO RELATED APPLICATIONS

This application claims the benefit of provisional patent application Ser. No. 60/553,379, filed Mar. 16, 2004, and provisional patent application Ser. No. 60/619,972, filed Oct. 19, 2004.

### FIELD OF THE INVENTION

This invention relates generally to a container having a plastic ring grip. More particularly, the invention is directed to a container having an easily gripped outer surface, and a process for making such a container.

### BACKGROUND OF THE INVENTION

Plastic containers that are generally used to package soft drinks and other beverages typically have a cylindrical sidewall configuration. Such containers are difficult to grip, especially when the exterior of the container becomes wet due to moisture or condensation, or when the container flexes and deforms upon being grasped by the hand.

It would be desirable to prepare a plastic container that has an embedded gripping feature on its exterior surface, so that the plastic container can be easily grasped.

### SUMMARY OF THE INVENTION

Accordant with the present invention, a container having a plastic ring grip has surprisingly been discovered. The container comprises an elastically deformable, substantially cylindrical sidewall, and a plastic ring contacting the exterior surface of the sidewall. The plastic ring has an inner circumference smaller than the circumference of the plastic container sidewall, so that the container sidewall exterior surface is concave at its point of contact with the plastic ring, thereby providing a grip in the sidewall of the plastic container. An optional handle may be attached to the plastic ring to facilitate handling of the plastic container.

The invention also contemplates a process for preparing a container having a plastic ring grip. The process comprises the steps of providing a plastic ring within a mold, the plastic ring having an inner circumference smaller than the circumference of the mold surface, inserting a plastic preform into the mold, and blow molding the preform to expand the preform axially through the plastic ring and simultaneously against the inner surface of the plastic ring, substantially into conformity with the mold surface to form the plastic container. The preform is constrained from contacting the mold surface at the points of contact between the preform and plastic ring, so that the plastic container sidewall exterior surface is concave at its point of contact with the plastic ring, thereby providing a grip in the sidewall of the container.

The invention also contemplates a process for preparing a container having a plastic ring grip including a handle. One process according to the invention comprises the steps of providing a plastic ring within a mold, the plastic ring having an inner circumference smaller than the circumference of the mold surface and having an attached handle, inserting a plastic preform into the mold, and blow molding the preform to expand the preform axially through the plastic ring and simultaneously against the inner surface of the plastic ring, substantially into conformity with the mold surface to form the plastic container.

The invention is particularly well-suited for preparing packaging for carbonated soft drinks, beverages, sports drinks, and the like.

### BRIEF DESCRIPTION OF THE DRAWINGS

The novel features which are characteristic of the present invention are set forth with particularity in the appended claims. However, the invention, as to structure and method of manufacture and use, will best be understood from the accompanying description of specific embodiments when read in conjunction with the drawings in which:

FIG. 1 is a perspective view of a plastic ring grip, according to the present invention;

FIG. 2 is a perspective view of a plastic ring grip, including a handle being gripped by a human hand;

FIG. 3 is a blow molded plastic container having a plastic ring grip contacting and embedded into the exterior cylindrical surface thereof; and

FIG. 4 is a blow molded plastic container having a plastic ring grip including a handle contacting and embedded into the exterior cylindrical surface thereof

### DETAILED DESCRIPTION OF THE PREFERRED EMBODIMENT

The present invention is directed to a plastic container, comprising: an elastically deformable, substantially cylindrical sidewall; and a plastic ring contacting the exterior surface of the sidewall, the plastic ring having an inner circumference smaller than the circumference of the plastic container sidewall so that the container sidewall exterior surface is concave at its point of contact with the plastic ring, thereby providing a grip in the sidewall of the plastic container. An optional handle may be attached to the plastic ring to facilitate handling of the plastic container.

The invention is also directed to processes for preparing plastic containers. One process according to the invention comprises the steps of: providing a plastic ring within a mold, the plastic ring having an inner circumference smaller than the circumference of the mold surface; inserting a plastic preform into the mold; and blow molding the preform to expand the preform axially through the plastic ring and simultaneously against the inner surface of the plastic ring, substantially into conformity with the mold surface to form the plastic container; wherein the preform is constrained from contacting the mold surface at the points of contact between the preform and plastic ring, so that the plastic container sidewall exterior surface is concave at its point of contact with the plastic ring, thereby providing a grip in the sidewall of the container. In the processes according to the invention, the plastic ring may have an attached handle.

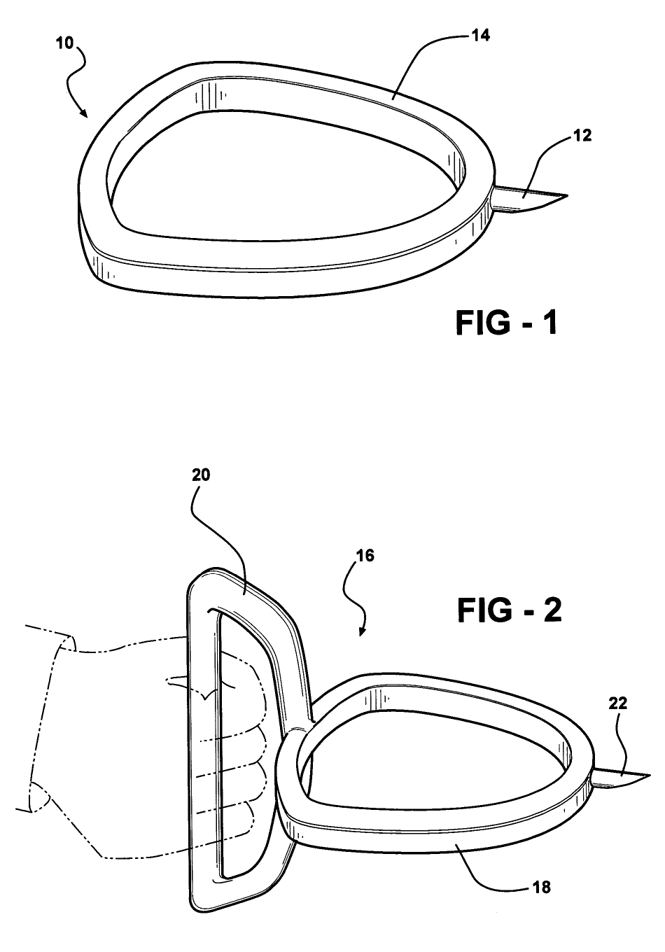

Referring now to the Drawings and particularly FIG. 1, there is shown generally at 10 a plastic ring grip according to the present invention. The plastic ring grip 10 includes a tab 12 for holding the plastic ring grip 10 in the blow molding mold cavity. Conveniently, the tab 12 may be gripped between the edges of the mold halves of a conventional blow molding operation, thus fixing the ring within the mold cavity for the subsequent blow molding operation. The preform is blown both axially and circumferentially so that the exterior surface of the preform contacts the inner surface 14 of the plastic ring grip 10.

FIG. 2 illustrates at 16 an alternative embodiment of the plastic ring grip, including a handle for more easily grasping the finished container. The plastic ring grip including a handle 16 comprises a non-circular ring portion 18 and a generally D-shaped handle 20. The tab 22 is again used to position and retain the plastic ring grip including a handle 16 within the molding cavity during the blow molding operation. FIG. 2 further illustrates a manner in which the plastic ring grip including a handle 16 may be grasped by a person's hand.

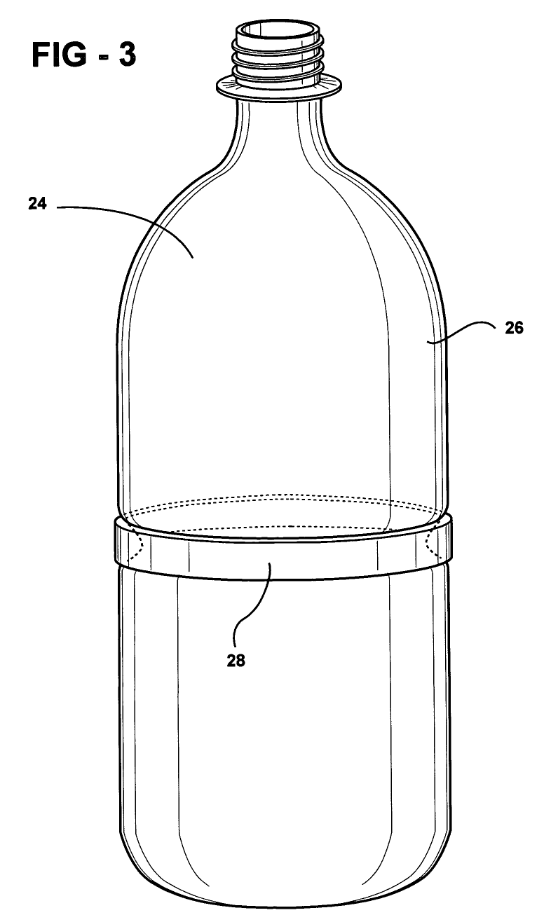

FIG. 3 illustrates a plastic container 24 having a generally cylindrical outer surface 26 and a plastic ring grip 28 contacting and embedded into the sidewall of the plastic container 24, according to the present invention. Note that the tab has been snapped off of the plastic ring grip 28 of the finished plastic container 24.

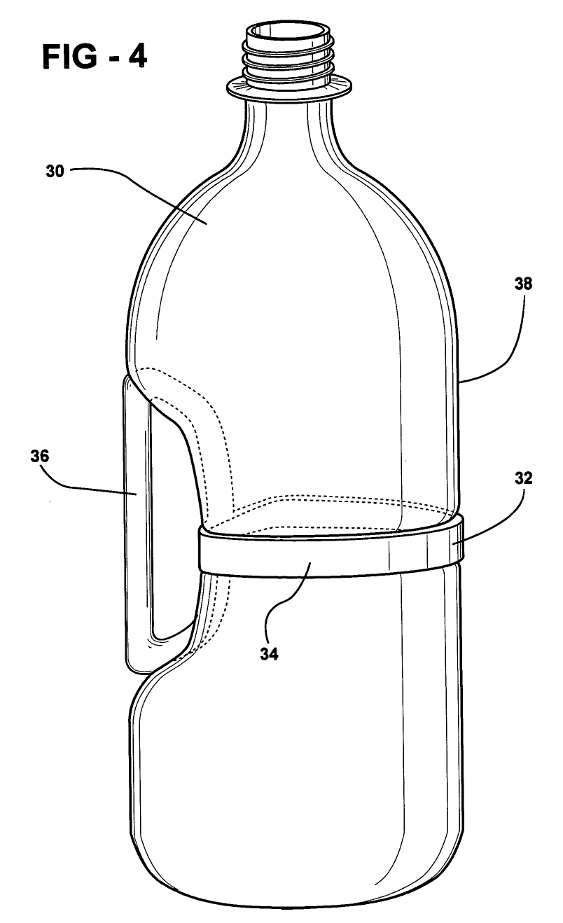

FIG. 4 illustrates an alternative plastic container 30 having a plastic ring grip including a handle 32. The non-circular ring portion 34 and part of the D-shaped handle 36 are contacting and embedded into the sidewall 38 of the plastic container 30. Again, the tab has been snapped off and is absent from the plastic ring grip including a handle 32.

The desired container may be prepared from any conventional material from which plastic containers having elastically deformable sidewalls are known to be made. Examples of materials from which plastic containers may be produced by typical blow molding processes comprise polyethylene terephthalate, polyolefin, polyester, polyamide, acrylonitrile, acid ester, vinyl chloride, and derivatives, blends, and copolymers of these materials with each other and with other polymers. A preferred material is polyethylene terephthalate.

The plastic ring, which forms a portion of the container gripping feature, likewise may comprise the same plastics mentioned hereinabove as useful for preparing the plastic container. Preferred materials for preparing the plastic ring grip comprise high density polyethylene and polypropylene. The plastic ring grip may be prepared by any conventional plastic manufacturing and forming process.

The handle, if included, may comprise the same materials described above as suitable for the plastic container and plastic ring grip. The handle may be formed of the same or different material as the plastic ring. Further, the handle may be a separate member that is connected to the plastic ring, or can be integrally formed with the plastic ring. The terms “including” and “attached,” as used herein to describe a structural relationship between the plastic ring and the handle, encompasses both of these relationships.

According to the present invention, the plastic ring is prepared to have an inner circumference that is smaller than the circumference of the cylindrical sidewall of the ultimately-produced plastic container. Preferably, the plastic ring has an outer diameter substantially equal to the inner diameter of the mold cavity at the position occupied by the plastic ring.

The plastic ring is positioned within a blow molding cavity, and is conveniently retained in position by a break-away tab which, for example, separates from the plastic ring during the molding process or at the time the blow molded container is discharged from the mold. Preferably, the plastic ring is positioned within the mold cavity below the distal portion of the uninflated preform.

According to the present invention, the hot preform from which the plastic container is produced is inserted into the mold. Thereafter, the mold is closed in anticipation of the blow molding step.

During the blow molding process, the preform begins to stretch radially, and a portion of the hot preform is forced against the inner surface of the plastic ring while the remainder of the hot preform is forced into conformity with the mold cavity surface. As will be apparent to one ordinarily skilled in the art, the expanding preform is constrained from contacting the mold surface at the point of contact between the expanding preform and the plastic ring. Accordingly, the expanding preform will contact the mold surface above and below the plastic ring, but the preform wall will assume a concave “groove” at its point of contact with the plastic ring. Thus, the ultimately-produced plastic container will have an exterior surface circumferential concave groove feature at its point of contact with the plastic ring.

According to the present invention, the exterior surface concave groove, which circumscribes the sidewall of the container, along with the plastic ring embedded therein, comprises the grip for conveniently grasping the plastic container.

If a handle is included, any suitable structure can be used. The handle need only provide a structure that allows grasping of the plastic container by the hand without requiring grasping around a portion of the circumference of the plastic container. One exemplary structure for the handle member comprises a closed loop that defines an opening. Grasping of the plastic container according to this exemplary embodiment can be accomplished by passing one's fingers through the opening substantially surrounding a portion of the closed loop defined by the handle.

The handle can be positioned in any suitable manner relative to the plastic ring. In one exemplary arrangement, the handle lies in a plane that is substantially perpendicular to a plane in which the plastic ring lies. This arrangement provides additional circumferential and vertical stability to the plastic container and facilitates handling of the container.

Similarly, the handle can be positioned in any suitable manner relative to the sidewall of the plastic container. In one exemplary embodiment, the container sidewall defines a recess that receives the handle member. An outer surface of the handle member can extend radially outwardly to substantially the same outer diameter as a portion of the container sidewall that does not define the recess. This configuration gives the plastic container a relatively low profile and enables space-conscious users, including retailers and consumers, to accommodate the plastic container in substantially the same space required to accommodate a similar plastic container that lacks a handle.

During the blow molding process, the handle may advantageously be inserted into a mold so that the handle member is disposed outside of the blow molding cavity. A mold defining a suitable recess may be used for this purpose.

The inventive process utilizes conventional preform preparations and blow molding operations that are well-known in the art.

The invention is more easily comprehended by reference to the specific embodiments herein, which are representative of the invention. It must be understood, however, that these embodiments are provided only for the purpose of illustration, and that the invention may be practiced otherwise than as specifically illustrated without departing from its spirit and scope.

1. A plastic container, comprising:
an elastically deformable, substantially cylindrical sidewall defining a circumferential groove;
a plastic ring disposed circumferentially about the sidewall and within the circumferential groove; and optionally a handle attached to the plastic ring.

2. The plastic container according to claim 1, wherein the sidewall comprises polyester, polyolefin, polyamide, acrylonitrile, acid ester, vinyl chloride, or a derivative, blend, or copolymer thereof.

3. The plastic container according to claim 2, wherein the sidewall comprises polyethylene terephthalate.

4. The plastic container according to claim 1, wherein the plastic ring comprises polyester, polyolefin, polyamide, acrylonitrile, acid ester, vinyl chloride, or a derivative, blend, or copolymer thereof.

5. The plastic container according to claim 4, wherein the plastic ring comprises high density polyethylene or propylene.

6. The plastic container according to claim 1, wherein the handle comprises polyester, polyolefin, polyamide, acrylonitrile, acid ester, vinyl chloride, or a derivative, blend, or copolymer thereof.

7. The plastic container according to claim 6, wherein the handle comprises the same material as the plastic ring.

8. A plastic container, comprising:
an elastically deformable, substantially cylindrical sidewall, the sidewall comprising polyester, polyolefin, polyamide, acrylonitrile, acid ester, vinyl chloride, or a derivative, blend, or copolymer thereof;
a plastic ring contacting the exterior surface of the sidewall, the plastic ring comprising polyester, polyolefin, polyamide, acrylonitrile, acid ester, vinyl chloride, or a derivative, blend, or copolymer thereof, the plastic ring having an inner circumference smaller than the circumference of the sidewall so that the sidewall exterior surface is concave at its point of contact with the plastic ring, thereby providing a grip in the sidewall of the plastic container; and optionally
a handle attached to the plastic ring, the handle comprising polyester, polyolefin, polyamide, acrylonitrile, acid ester, vinyl chloride, or a derivative, blend, or copolymer thereof.

9. The plastic container according to claim 8, wherein the sidewall comprises polyethylene terephthalate.

10. The plastic container according to claim 8, wherein the plastic ring comprises high density polyethylene or propylene.

11. The plastic container according to claim 8, wherein the handle comprises the same material as the plastic ring.

12. A process for preparing a plastic container, comprising the steps of:
providing a plastic ring within a mold, the plastic ring having an inner circumference smaller than the circumference of the mold cavity surface;
inserting a plastic preform into the mold; and
blow molding the preform, to expand the preform axially through the plastic ring and simultaneously against the inner surface of the plastic ring, substantially into conformity with the mold surface, to form the plastic container;
wherein the preform is constrained from contacting the mold surface at the points of contact between the preform and plastic ring, so that the plastic container sidewall exterior surface is concave at its point of contact with the plastic ring, thereby providing a grip in the sidewall of the container.

13. The process according to claim 12, wherein the plastic ring comprises polyester, polyolefin, polyamide, acrylonitrile, acid ester, vinyl chloride, or a derivative, blend, or copolymer thereof.

14. The process according to claim 13, wherein the plastic ring comprises high density polyethylene or propylene.

15. The process according to claim 12, wherein the sidewall comprises polyester, polyolefin, polyamide, acrylonitrile, acid ester, vinyl chloride, or a derivative, blend, or copolymer thereof.

16. The process according to claim 15, wherein the sidewall comprises polyethylene terephthalate.

17. The process according to claim 12, wherein the plastic ring includes a handle attached thereto.

18. The process according to claim 17, wherein the handle comprises polyester, polyolefin, polyamide, acrylonitrile, acid ester, vinyl chloride, or a derivative, blend, or copolymer thereof.

19. The process according to claim 17, wherein the handle comprises the same material as the plastic ring.
